(19) United States
(12) Patent Application Publication
(10) Pub. No.: US 2008/0164677 A1
(43) Pub. Date: Jul. 10, 2008

(54) FIFTH WHEEL REDUCED-FRICTION PLATE

(75) Inventor: Todd M. Huntimer, Arlington, SD (US)

Correspondence Address: BLACK LOWE & GRAHAM, PLLC, 701 FIFTH AVENUE, SUITE 4800, SEATTLE, WA, 98104, US

(73) Assignee: Global Polymer Industries, Inc., Arlington, SD (US)

(21) Appl. No.: 11/620,003

(22) Filed: Jan. 4, 2007

(51) Int. Cl. B62D 53/08; B21D 53/10

(52) U.S. Cl. 280/433; 29/898.07

(57) ABSTRACT

A fifth wheel hitch lube plate includes a support plate moldably coupled to a cover. By way of example, the support plate is a metallic plate with a number of openings and/or cavities. Some of the openings are configured to receive fasteners while other openings, referred to as cover locking cavities, are configured to cooperate with the cover during the molding operation to mechanically lock or couple the cover to the support plate. The cover locking cavities include an upper, narrow passage that is in communication with a lower, larger cavity. At least a portion of the cover is supported by a top surface of the support plate.

### FIELD OF THE INVENTION

The present invention generally pertains to a fifth wheel reduced-friction plate that can be fastened or otherwise connected to a fifth wheel hitch assembly to reduce friction between operationally cooperating hitch assemblies.

### BACKGROUND OF THE INVENTION

A fifth wheel hitch is commonly found on a tractor (e.g., tractor-trailer cab) and is used for hauling large trailers. The fifth wheel hitch includes a large bifurcated hitch bearing plate that receives a kingpin, which is then locked in place with one or more jaws. The kingpin is coupled to a bearing plate located on a trailer. The trailer bearing plate rests upon and pivots on the upper surface of the hitch bearing plate to enable articulation between the tractor and its towed trailer. A layer or film of grease is located between the respective bearing plates on the tractor and the trailer. This film or grease must be continually maintained to reduce sticking, galling, and other forms of wear or damage to the respective bearing plates. The film or grease tends to retain dirt, dust and other debris, which increases the friction and may reduce the operational life of the bearing plates.

Various attempts have been made in the past to provide a lubricious surface layer for the hitch bearing plates without employing extensive amounts of grease as is normally required. These attempts are described in the background section of U.S. Pat. No. 7,036,839 to Hungerlink et al. (hereinafter referred to as Hungerlink), and which is incorporated by reference herein.

To overcome at least some of these problems, Hungerlink discloses a fifth wheel hitch lube plate having a perforated support member. A lubricious material is molded around the perforated support member and covers both the top and bottom surfaces of the perforated support member. The lubricious material extends through the perforations formed in the perforated support member. Hungerlink teaches that the support member is preferably a perforated metal plate and the lubricious material is nylon, graphite, or an ultra-high molecular weight (UHMW) material. The fifth wheel hitch lube plate as described by Hungerlink is marketed and sold as the LOWLUBE™ fifth wheel by The Holland Group, Inc. located in Holland, Mich.

It would be desirable to have a fifth wheel hitch lube plate that can be used with a variety of vehicles. The fifth wheel hitch lube plate should overcome at least some of the aforementioned drawbacks and preferably have a lower overall weight and have sufficient manufacturability.

### SUMMARY OF THE INVENTION

According to at least one embodiment of the invention, a fifth wheel contact plate includes a support plate moldably coupled to a low-friction cover. In one example, the support plate is a metallic support plate with a number of openings. The openings comprise a narrow passage in communication with a larger cavity. At least a portion of the cover is positioned against a top surface of the support plate.

In one aspect of the invention, a fifth wheel contact plate to be received on a fifth wheel hitch plate includes a support plate having a top surface, a bottom surface, and at least one opening extending through the support plate from the top surface to the bottom surface, the at least one opening having a recess cavity extending from the bottom surface toward the top surface and a narrow passage cavity extending from the top surface toward the bottom surface, the recess cavity being larger than the narrow passage cavity and in communication therewith; and a cover moldably coupled to the support plate, the cover having an upper plate portion supported on the top surface of the support plate and a locking portion that extends from the upper portion and substantially fills both the recess cavity and the narrow passage cavity of the at least one opening in the support plate, at least a top surface of the cover having a low coefficient of friction.

In another aspect of the invention, a method of manufacturing a low friction bearing plate to be assembled with a fifth wheel hitch plate includes the steps of (1) forming a plurality of openings in a support plate, at least some of the openings having a recess cavity extending from a bottom surface of the support plate toward a top surface of the support plate and a narrow passage cavity extending from the top surface toward the bottom surface, the recess cavity being larger than the narrow passage cavity and in fluid communication therewith; (2) moldably coupling a low-friction material to the support plate by viscously arranging the low-friction material on an upper surface of the support plate and receiving the low-friction material into the recess cavities and the narrow passage cavities of the openings; and (3) cooling the low-friction material to the secure the low-friction material to the support plate wherein the low-friction material substantially covers the upper surface of the support plate and is substantially flush with a bottom surface of the support plate adjacent the recess cavities of the openings.

As will be readily appreciated from the foregoing summary, the invention provides a fifth wheel contact plate made from a cover moldably coupled to a support plate. Preferably, the cover is made from a low-friction material. The low-friction fifth wheel contact plate may advantageously reduce the operational costs associated with conventional fifth wheel hitch plates, which costs typically include periodic grease or lubrication maintenance and may further include periodic structural inspections.

### BRIEF DESCRIPTION OF THE DRAWINGS

The preferred and alternative embodiments of the present invention are described in detail below with reference to the following drawings:

FIG. 1 is an isometric view of a fifth wheel hitch plate having left and right contact plates thereon according to an embodiment of the invention;

FIG. 2 is an isometric view of one of the contact plates of FIG. 1 made from a support plate moldably coupled to a cover;

FIG. 3 is a cross-sectional view of the contact plate of FIG. 2 taken along Line 3-3 of FIG. 2 showing the fastener openings and cover locking cavities according to an embodiment of the invention;

FIG. 4 is a close-up, partial cross-sectional view of the support plate of FIG. 3;

FIG. 5 is a top isometric view of the support plate of FIG. 2 having countersunk fastener openings and cover locking cavities according to an embodiment of the invention; and

FIG. 6 is a bottom isometric view of the support plate of FIGS. 2 and 5.

### DETAILED DESCRIPTION OF THE PREFERRED EMBODIMENT

In the following description, certain specific details are set forth in order to provide a thorough understanding of various embodiments of the invention. In other instances, well-known structures and methods associated with fifth wheel hitch plates and methods of making and/or assembling the same may not be shown or described in detail to avoid unnecessarily obscuring descriptions of the embodiments of the invention.

The following description generally relates to a fifth wheel hitch lube plate that includes a cover moldably coupled to a support plate. By way of example, the support plate is a metallic plate with a number of openings and/or cavities. A first number of openings are configured to receive fasteners while a second number of openings, referred to as cover locking cavities, are configured to cooperate with the cover during the molding operation to mechanically lock or couple the cover to the support plate. The cover locking cavities include an upper, narrow passage that is in communication with a lower, larger cavity. At least a portion of the cover is supported by a top surface of the support plate.

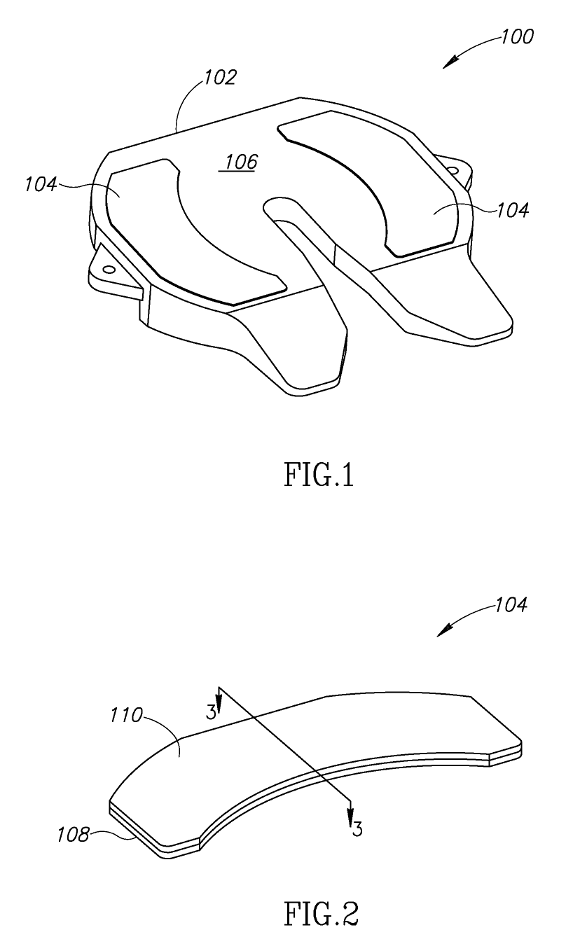

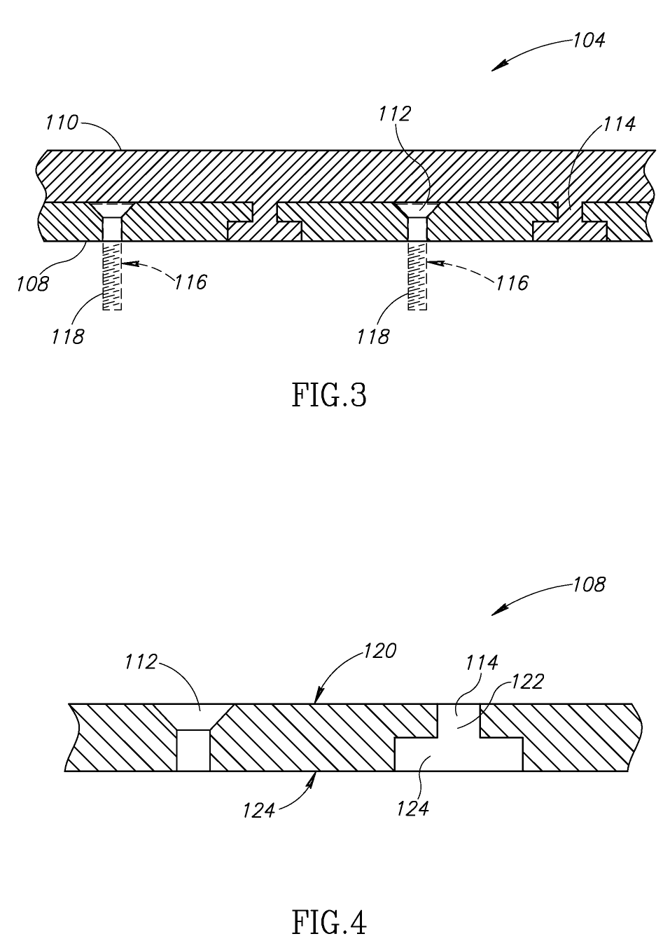

FIG. 1 shows a fifth wheel hitch plate assembly 100 that includes a hitch plate 102 having left and right contact plates 104 mounted onto an upper surface 106 of the hitch plate 102. The hitch plate assembly 100 may be used, for example, to couple a tractor trailer (not shown) to a semi-truck tractor (not shown). The hitch plate assembly 100 may be custom made to receive heavy or light loads. In one embodiment, the hitch plate assembly 100 is mounted to a pickup truck (not shown) to receive a recreational vehicle (not shown). In one embodiment, the cover 104 is mounted to the hitch plate 102 with fasteners (FIG. 3).

FIG. 2 shows one of the contact plates 104 from FIG. 1, which includes a support plate 108 and a cover 110. Preferably, the support plate 108 is a relatively thin metallic plate, but it may also be made from a reinforced composite material or some other material having sufficient strength, ductility, and impact toughness. The cover 110, according to one embodiment, is made from an ultra high molecular weight (UHMW) polymer material (such as polyethylene). In another embodiment, the cover is made from a nylon reinforced composite material or some other material having a sufficiently low coefficient of friction.

FIG. 3 is a portion of the contact plate 104 showing the support plate 108 being moldably coupled to the cover 110. The support plate 108 includes first openings 112 and second openings 114. In one embodiment, the first openings 112 are configured as countersunk fastener openings to receive countersunk fasteners 116. During assembly of the contact plate 104 with the hitch plate 102 (FIG. 1), a threaded portion 118 of the countersunk fasteners 116 are received into openings in the fifth wheel hitch plate 102. Appropriate nuts and washers (not shown) are used to affix the contact plates 104 to the fifth wheel hitch plate 102. For example, hexagonal headed bolts or other geometrically shaped fasteners to better resist rotation.

FIG. 4 shows the support plate 108 of the contact plate 104. As previously noted, the support plate 108 includes first openings 112 to receive fasteners 116 and second openings 114 configured to mechanically lock the cover 110 to the support plate 108. During a molding operation, the cover 110 is in a flowable, fluid form as it is placed or injected onto the support plate 108. The flowable cover material 110 substantially fills the second openings 114 and builds up on a top surface 120 of the support plate 108. The second openings 114 include a narrow, upper passage 122 and a wider, lower passage or cavity 124, which is in fluid communication with the upper passage 122. In one embodiment, the wider, lower passage 124 is in the shape of a counterbore. In another embodiment, the walls of the lower passage 124 extend from the upper passage 122 at an angle to form a partial cone. It is appreciated the lower passage 122 may have any shape that accomplishes the function of substantially locking the cover 110 to the support plate 108.

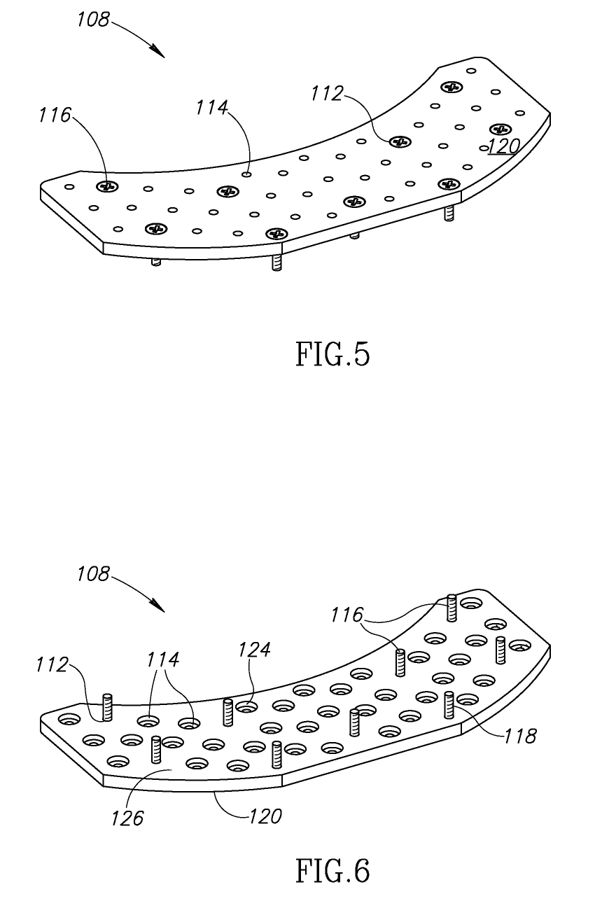

FIG. 5 shows an upper isometric view of the top surface 120 of the support plate 110. The first openings 112 receive fasteners 116, and as shown in FIG. 5, yet best shown in FIG. 3, the head of the fastener 116 are substantially flush with the top surface 120 of the support plate 108. The narrow, upper passages 122 of the second openings 114 are proximate the top surface 120 of the support plate. The number and arrangement of the first openings 112 correspond to the openings in the hitch plate 102 (FIG. 1) that will receive the fasteners 116. The number and arrangement of the second openings 114 are variable and based on design criteria such as the strength of the cover 110, the thickness of the support plate 108, the material of the support plate 108, etc.

FIG. 6 shows a bottom isometric view of a lower surface 126 of the support plate 108. The threads 118 of the fasteners 116, which are in the first openings 112, extend past the lower surface 126 of the support plate 108. The wider, lower passages 124 of the second openings 114 are proximate the lower surface 120 of the support plate 108.

In sum, the contact plates 104 described herein may advantageously provide a low-friction alternative to the periodic greasing and/or lubricating that is required on conventional hitch plates. In addition, the arrangement and configuration of the second openings 114 in the support plate 108 provide a robust attachment between the cover 110 and the support plate 108 while reducing the overall weight of the contact plate 104. For example, the cover 110 may be formed primarily on the upper surface 120 of the support plate 108, but not extend around or be located adjacent the bottom surface 126 of the support plate 108.

These and other changes can be made in light of the above detailed description. In general, in the following claims, the terms used should not be construed to limit the invention to the specific embodiments disclosed in the specification and the claims, but should be construed to include all types of fifth wheel hitch plates and components thereof, to include but not limited to contact plates that operate in accordance with the claims.

While the preferred embodiment of the invention has been illustrated and described, as noted above, many changes can be made without departing from the spirit and scope of the invention. For example, other types of covers, which are moldable and have low friction properties, can be configured to achieve similar advantages as the covers described above. Accordingly, the scope of the invention is not limited by the disclosure of the preferred embodiment. Instead, the invention should be determined by reference to the claims that follow.

1. A fifth wheel contact plate to be received on a fifth wheel hitch plate, the fifth wheel: contact plate comprising:
a support plate having a top surface, a bottom surface, and at least one opening extending through the support plate from the top surface to the bottom surface, the at least one opening having a recessed cavity extending from the bottom surface toward the top surface and a narrow passage cavity extending from the top surface toward the bottom surface, the recess cavity being larger than the narrow passage cavity and in communication therewith; and
a cover moldably coupled to the support plate, the cover having an upper plate portion supported on the top surface of the support plate and a locking portion that extends from the upper portion and substantially fills both the recess cavity and the narrow passage cavity of the at least one opening in the support plate, at least a top surface of the cover having a low coefficient of friction.

2. The fifth wheel contact plate of claim 1, wherein the locking portion of the cover provides shear continuity between the cover and the support plate.

3. The fifth wheel contact plate of claim 1, wherein the recessed cavity of the support plate is in the shape of a counterbored cavity.

4. The fifth wheel contact plate of claim 1, wherein the support plate includes a countersunk opening extending through the support plate, and where the countersunk opening is located proximate the top surface of the support plate.

5. The fifth wheel contact plate of claim 1, wherein cover is made from an ultra high molecular weight plastic material.

6. A fifth wheel hitch plate assembly comprising:
a fifth wheel hitch plate mountable to a vehicle; and
a fifth wheel contact plate coupled to the fifth wheel hitch plate, the contact plate including a support plate and a cover, the support plate having a top surface, a bottom surface, and at least one opening extending through the support plate from the top surface to the bottom surface, the at least one opening having a recessed cavity extending from the bottom surface toward the top surface and a narrow passage cavity extending from the top surface toward the bottom surface, the recess cavity being larger than the narrow passage cavity and in communication therewith, the cover moldably coupled to the support plate, the cover having an upper plate portion supported on the top surface of the support plate and a locking portion that extends from the upper portion and substantially fills both the recess cavity and the narrow passage cavity of the at least one opening in the support plate, at least a top surface of the cover having a low coefficient of friction.

7. The assembly of claim 6, wherein the locking portion of the cover provides shear continuity between the cover and the support plate.

8. The assembly of claim 6, wherein the recessed cavity of the support plate is in the shape of a counterbored cavity.

9. The assembly of claim 6, wherein the support plate includes a countersunk opening extending through the support plate, and where the countersunk opening is located proximate the top surface of the support plate.

10. The assembly of claim 6, wherein cover is made from an ultra high molecular weight plastic material.

11. A method of manufacturing a low friction bearing plate to be assembled with a fifth wheel hitch plate, the method comprising:
forming a plurality of openings in a support plate, at least some of the openings having a recess cavity extending from a bottom surface of the support plate toward a top surface of the support plate and a narrow passage cavity extending from the top surface toward the bottom surface, the recess cavity being larger than the narrow passage cavity and in fluid communication therewith;
moldably coupling a low-friction material to the support plate by forming the low-friction material over an upper surface of the support plate and receiving the low-friction material into the recess cavities and the narrow passage cavities of the support plate; and
cooling the low-friction material to the substantially lock the low-friction material to the support plate wherein the low-friction material substantially covers the upper surface of the support plate and portions of the low-friction material are substantially flush with a bottom surface of the support plate adjacent the recess cavities formed therein.

12. The method of claim 11, wherein moldably coupling the low-friction material to the support plate includes compression molding the low-friction material to the support plate.

13. The method of claim 11, wherein moldably coupling the low-friction material to the support plate includes injection molding the low-friction material to the support plate.

14. The method of claim 11, wherein moldably coupling the low-friction material to the support plate includes moldably coupling an ultra high molecular weight plastic material to the support plate.
